(19) United States
(12) Patent Application Publication
(10) Pub. No.: US 2008/0120562 A1
(43) Pub. Date: May 22, 2008

(54) Display Control Method and Computer Program Product Thereof

(75) Inventor: Masato HONDA, Nisshin-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/942,243

(22) Filed: Nov. 19, 2007

(30) Foreign Application Priority Data
Nov. 22, 2006 (JP) 2006-315878

(51) Int. Cl. G06F 3/048

(52) U.S. Cl. 715/767

(57) ABSTRACT

One aspect of the present invention can include a display control for a dialog box to be displayed on a display device, which includes determining if voice reading software for making pronunciation based on a character string displayed on the display device is available, and displaying a dialog box on the display device in a first display aspect when it is determined that the voice reading software is not available, and displaying a dialog box on a display device in a second display aspect when it is determined that the voice reading software is available. Also, the second display aspect is more adaptable to the voice reading software than the first display aspect.

### CROSS REFERENCE TO RELATED APPLICATION

This application claims priority from Japanese Patent Application No. 2006-315878 filed Nov. 22, 2006. The entire content of this priority application is incorporated herein by reference.

### TECHNICAL FIELD

The present invention relates to a computer program product including a display control program and a display control method for a dialog box to be displayed on a display device.

### BACKGROUND

There has been a devices which guides a user to determine whether or not he needs voice guidance for settings, when a printer driver is activated in a computer, and executes a function of reading characters displayed on a display device only when the user inputs an instruction indicating that he needs the voice guidance for setting with a keyboard. According to this device, when the voice guidance for setting is not selected, the reading function is not executed, and normal interface with a user (non-handicapped person) can be provided. On the other hand, when the voice guidance for setting is selected, interface with a user (such as a visually impaired person) by voice guidance can be provided.

In the case of the above conventional configuration, however, it is common to use a package including not only the printer driver but also special voice data for voice guidance to aid in the installation or setting of the printer driver. Yet, the use of special voice data can result in a package including a very large amount of data. Therefore, there is a need in the art for a configuration that does not need special voice data.

### SUMMARY

One aspect of the present invention can include a display control for a dialog box to be displayed on a display device, which includes determining if voice reading software for making pronunciation based on a character string displayed on the display device is available, and displaying a dialog box on the display device in a first display aspect when it is determined that the voice reading software is not available, and displaying a dialog box on a display device in a second display aspect when it is determined that the voice reading software is available. Also, the second display aspect is more adaptable to the voice reading software than the first display aspect.

### BRIEF DESCRIPTION OF THE DRAWINGS

Illustrative aspects in accordance with the invention will be described in detail with reference to the following figures wherein:

FIG. 1 is a block diagram of a printing system according to an aspect of the present invention;

FIG. 2 is a schematic diagram showing a top menu image of a first display aspect;

FIG. 3 is a schematic diagram showing a top menu image of a second display aspect;

FIG. 4 is a flowchart showing the contents of processing on the basis of a display control program;

FIG. 5 is a schematic diagram showing a dialog box screen displayed by a first printer driver;

FIG. 6 is a schematic diagram showing a dialog box screen displayed by a second printer driver;

FIG. 7 is a schematic diagram showing a first display aspect of a dialog box of a variation aspect; and

FIG. 8 is a schematic diagram showing a second display aspect of a dialog box of a variation aspect.

### DETAILED DESCRIPTION OF THE PREFERRED ILLUSTRATIVE ASPECTS

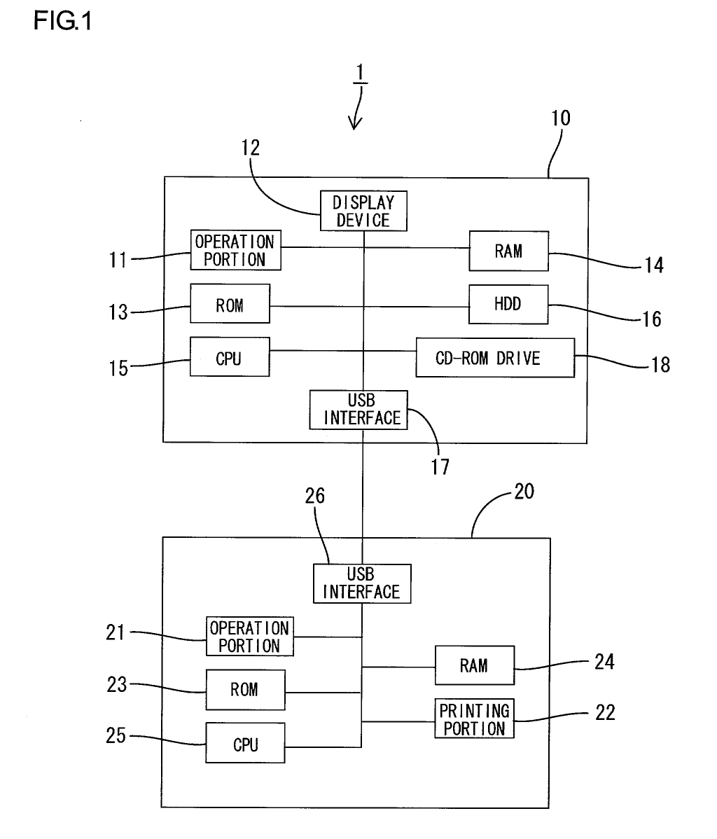

An aspect of the present invention will be described with reference to FIGS. 1 to 4.

1. Configuration of a Printing System

FIG. 1 is a block diagram showing the configuration of a printing system 1 according to this aspect. This printing system 1 is configured by a terminal apparatus 10 and a printing apparatus 20 which are locally connected, for example, via USB ports.

(1) Terminal Apparatus

The terminal apparatus 10 (for example, a local computer or a server computer) is configured to include an operation portion 11 on which a user performs, for example, an input operation, a display device 12, a ROM 13, a RAM 14, a CPU 15 (an example of a “computer”), a hard disk drive 16, a USB interface 17 and a CD-ROM drive 18.

In the hard disk drive 16, application software for creating information to be printed, and the like, can be recorded. In a recording medium (in this aspect, a CD-ROM) which is provided in the kit of the printing apparatus 20, a setup program, a printer driver (an example of a “predetermined program”), and a display control program to be described later are recorded. The CPU 15 reads the application software from the hard disk 16 to and activates it, or reads the setup program or the like from the CD-ROM drive 18 and activates it, on the basis of an activation instruction from the operation portion 11.

When the printer driver is installed, the CPU 15 constructs the printing system 1 described above. When an instruction requesting for printing by the user is issued by the operation portion 11, the CPU 15 sends data to be printed which has been created by the application software, to the printer driver. The printer driver performs development (conversion) processing for converting the data to PDL data which can be printed, and then sends the data via the USB interface 17.

(2) Printing Apparatus

The printing apparatus 20 is provided with an operation portion 21 on which a predetermined operation is performed, a printing portion 22 which controls the operation of printing on paper, a ROM 23, a RAM 24, a CPU 25, and a USB interface 26. In the ROM 23, a program(s) are stored which can give a reply to an inquiry from the terminal apparatus 10, which can perform processing in response to an instruction from the terminal apparatus 10, and which can control the operation of the whole printing apparatus 20, and the like.

The CPU 25 executes data processing on the basis of the programs stored in the ROM 23. That is, when receiving the PDL data from the terminal apparatus 10 via the USB interface 26, the CPU 25 performs printer language processing (PDL processing) of the PDL data and sends it to the printing portion 22. Then, the printing portion 22 executes a printing operation of printing information corresponding to the above-described data to be printed, on a recording medium (i.e. paper sheet, plastic sheet, or the like) on the basis of the sent data.

2. Initial Setup Work and Voice Reading Software

Predetermined initial setup work is preformed to construct the printing system 1 described above. For example, the terminal apparatus 10 and the printing apparatus 20 are connected so that they can perform data communication with each other and to install the printer driver of the printing apparatus 20 in the terminal apparatus 10. In this case, when the setup program is activated, the CPU 25 sequentially displays multiple dialog boxes which instruct the setup work procedure and the like on the display device 12 in accordance with the setup program. Therefore, the setup work can be performed relatively easily by following the contents of the display of the dialog box shown on this display device 12.

However, if the user is, for example, a visually impaired person, it may be required to communicate the contents of the display of the dialog box by voice. The display control program of this aspect does not require special voice data, rather general-purpose voice reading software is provided to enable even a visually impaired person to easily perform setup work.

The voice reading software reads each character string displayed at each display position on the display screen of the display device 12. Specifically, the application activated currently manages data of each display position on the display screen and character data to be displayed at the display position in association with each other. When a certain display position is specified by a cursor, the CPU 15 acquires character data corresponding to the display position data from the application. Then, the CPU 15 converts the character data to voice data, and this voice data is outputted by a speaker or the like (not shown) which is connected to the terminal apparatus 10. There may be a case where a visually impaired person cannot visually confirm the position of the cursor at all. In this case, the display area specified by the cursor on the display screen can be changed to the other display areas sequentially, for example, each time the tab key on the operation portion 21 (keyboard) console is pushed. For each display area specified by the cursor, the character string displayed therein is outputted by a voice. For example, JAWS for Windows (registered trademark) and PC-TALKER are examples of the voice reading software.

3. Dialog Box

As described above, the voice reading software acquires character data corresponding to the character string displayed on the display screen. That is, if kanji characters (Chinese character) are displayed, character data in kanji characters is acquired. If hiragana or katakana (Katakana are characters adapted from kanji used mainly for foreign words) characters are displayed, character data in hiragana or katakana characters is acquired. The reading accuracy of the voice reading software is high in the case of katakana or hiragana character data.

Therefore, in the storage medium, data of multiple dialog box images are recorded together with the display control program. The respective dialog box images are sequentially displayed on the display device 12 at the timing based on the setup program. Normal dialog box images of a first display aspect and dialog box images for visually impaired persons of a second display aspect are prepared in advance as the dialog box images to be displayed at each timing.

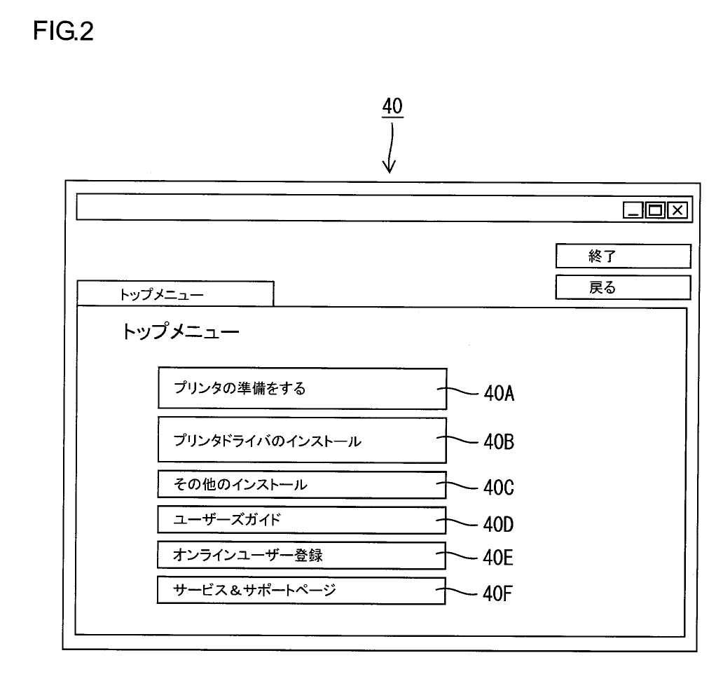

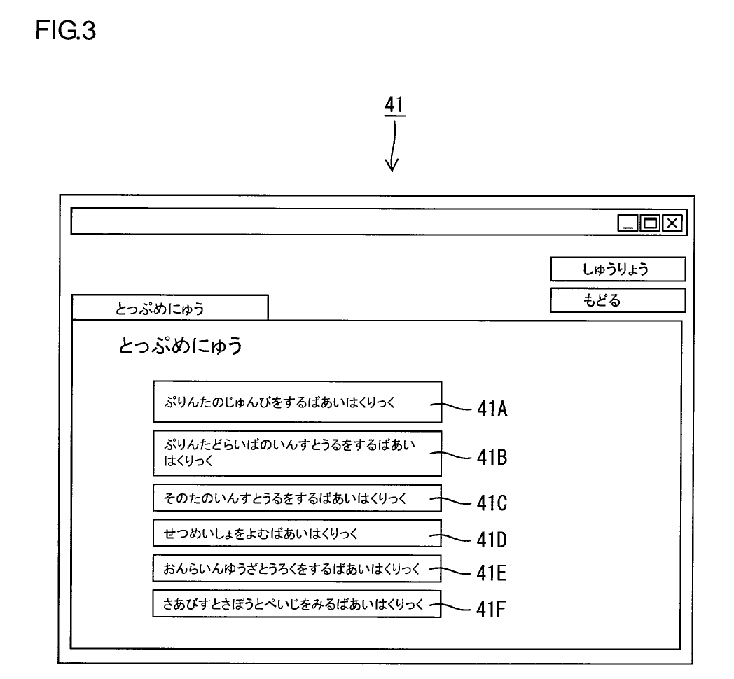

A top menu image is shown in FIGS. 2 and 3. The top menu image is a dialog box displayed first when the setup program is activated. In FIG. 2, a top menu image 40 of the first display aspect is shown. As seen from the figure, the character string in each display area is shown with kanji characters included, in this first display aspect. If the user is not a visually impaired person, a character string including kanji characters as in the first display aspect is generally easier to read than a character string including only hiragana or katakana characters.

However, in the case of a character string including kanji characters as in the first display aspect, the reading accuracy of the voice reading software may deteriorate as described above. Therefore, a top menu image 41 of the second display aspect is prepared as shown in FIG. 3. In this second display aspect, the character string in each display area includes only hiragana (the Japanese cursive syllabary) characters. Furthermore, the contents of the display are more detailed than those of the top menu image 40 of the first display aspect. For example, on the first line 40A in the top menu image 40 of the first display aspect, a character string including kanji characters is displayed which means, “Make preparation for printer”. On the first line 41A in the top menu image 41 of the second display aspect corresponding to the first line 40A in the top menu image 40, a character string including only hiragana characters is displayed which means, “Click to make preparation for printer”, and further, the operation method is also displayed. On the second line 40B in the top menu image 40, a character string including katakana characters is displayed which means, “Install printer driver”. On the second line 41B in the top menu image 41 corresponding to the second line 40B in the top menu image 40, a character string including only hiragana characters is displayed which means, “Click to install printer driver”. On the third line 40C in the top menu image 40, a character string including kanji and katakana characters is displayed which means “other installations”. On the third line 41C in the top menu image 41 corresponding to the third line 40C in the top menu image 40, a character string including only hiragana characters is displayed which means, “Click to perform other installations”.

Furthermore, on the fourth line 40D in the top menu image 40, a character string in katakana characters is displayed which means “user's guide”. On the fourth line 41D in the top menu image 41 corresponding to the fourth line 40D in the top menu image 40, a character string including only hiragana characters is displayed which means, “Click to read manual”. Furthermore, on the fifth line 40E in the top menu image 40, a character string including katakana and kanji characters is displayed which means “online user registration”. On the fifth line 41E in the top menu image 41 corresponding to the fifth line 40E in the top menu image 40, a character string including only hiragana characters is displayed which means, “Click to perform online user registration”. On the sixth line 40F in the top menu image 40, a character string in katakana characters is displayed which means “service & support page”. On the sixth line 41F in the top menu image 41 corresponding to the sixth line 40F in the top menu image 40, a character string including only hiragana characters is displayed which means, “Click to see service & support page”.

Thus, when the top menu image 41 of the second display aspect is displayed on the display device 12, more accurate and more detailed contents are read by voice, in comparison with the case where the top menu image 40 of the first display aspect is displayed.

4. Contents of Control Based on the Display Control Program

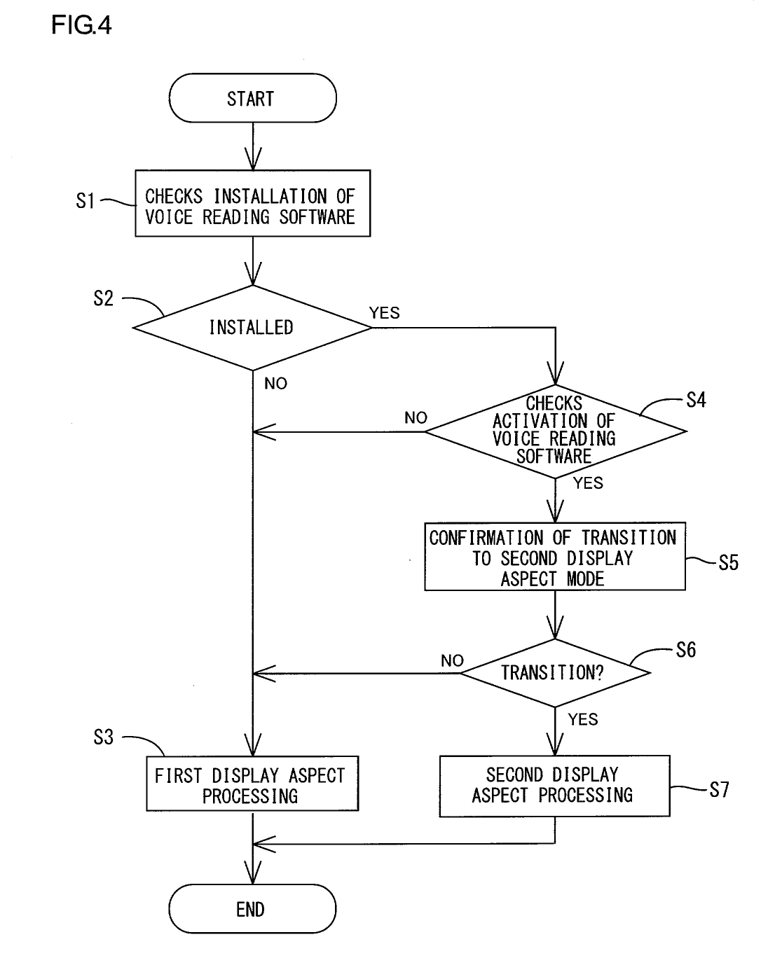

When the setup program is activated to construct the printing system 1, the CPU 15 performs processing in accordance with the setup program. During the processing of the setup program, various kinds of dialog boxes for causing a user to select respective setting conditions and the like are displayed on the display device 12. The CPU 15 executes processing in accordance with the display control program shown in FIG. 4 at the timing when each dialog box is displayed. The CPU 15 first determines whether voice reading software has been installed in the hard disk 16 or not at S1. That is, the CPU 15 executes “installation determination process”. This determination can be performed, for example, by inquiring at the operating system which manages the whole terminal apparatus 10.

If the voice reading software is not installed (S2: N), then the CPU 15, at S3, reads the data of the dialog box images of the first display aspect from the hard disk 16 and displays the dialog box images of the first display aspect (see FIG. 2, for example) on the display device 12. Then, it ends the processing.

On the other hand, if the voice reading software is installed (S2: Y), then the CPU 15 determines if the voice reading software has been activated at S4. That is, the CPU 15 executes “activation determination process”. This determination can be performed, for example, by inquiring at the operating system which manages the whole terminal apparatus 10. If the voice reading software has not been activated (S4: N), then the CPU 15 proceeds to S3 described above to display the dialog box images of the first display aspect on the display device 12. Then, it ends the processing. On the other hand, if the voice reading software has been activated (S4: Y), a selection screen for selecting whether or not to proceed to a second display aspect mode for displaying the dialog boxes of the second display aspect (display only in hiragana characters) is displayed on the display device 12 at S5. That is, the CPU 15 executes “user's selection process”.

If the user selects “not to proceed” (S6: N), then the CPU 15 again proceeds to S3 to display the dialog box images of the first display aspect on the display device 12. Then, it ends the processing. On the other hand, if the user selects “to proceed” (S6: Y), the CPU 15, for the first time, reads the data of the dialog box images of the second display aspect from the hard disk 16 and displays the dialog box images of the second display aspect (see FIG. 3, for example) on the display device 12 at S7. Then, it ends the processing. That is, the CPU 15 executes “switching process”. As described above, a character string can be expressed only in hiragana characters in the second display aspect, and the second display aspect is a display aspect adapted to voice reading software, in other words, a display aspect with high compatibility with voice reading software. Therefore, voice reading is performed more accurately in comparison with the case where the dialog box images of the first display aspect are displayed.

For example, if activation of the voice reading software is stopped (S4: N) during the processing by the setup program, the dialog box screen of the first display aspect is displayed after that.

<Other Aspects>

The present invention is not limited to the aspect which has been explained in the above description with reference to the drawings. For example, the following aspects are also included in the technical scope of the present invention.

(1) In the configuration of the above aspect, the dialog boxes of the second display aspect are displayed on the condition that the voice reading software has been installed and activated, but the present invention is not limited to this. A configuration is also possible in which the dialog boxes of the second display aspect are displayed only on the condition that the voice reading software has been installed, without checking whether it has been activated or not. However, if it is checked whether the voice reading software has been activated or not, as in the above aspect, it is also determined whether there is a possibility that the terminal apparatus 10 is currently used by a user that wants or needs voice reading software, and the display aspects of the dialog boxes can be switched more appropriately.

(2) In the configuration of the above aspect, when activation of the voice reading software is confirmed, selection of whether or not to proceed to the second display aspect mode is left to a user, but the present invention is not limited to this. A configuration is also possible in which the mode transitions to the second display aspect mode when activation of the voice reading software is confirmed, without this selection. However, if the configuration of the above aspect is used, for example, it is possible to use the terminal apparatus 10 to display the dialog box in the first display aspect by selecting not to proceed to the second display aspect mode, though the voice reading software has been activated.

(3) In the above aspect, a character string expressed only in hiragana characters is shown as the second display aspect, but the present invention is not limited to this. A character string expressed only in katakana characters or only in hiragana and katakana characters is also possible.

(4) As the second display aspect, a configuration is also possible in which the display size of a character string on the display device 12 is enlarged. Thereby, a person whose visual impairment level is low can visually and aurally confirm the contents of the display.

(5) In the above aspect, it is described that the dialog box display is provided when the setup program is activated as an example, but the present invention is not limited to this. The present invention may be applied to each dialog box display when a different application (for example, a printer driver) is activated (for example, the dialog box display for print settings). However, the first and second display aspects dialog box images, should be prepared for this aspect of the present invention.

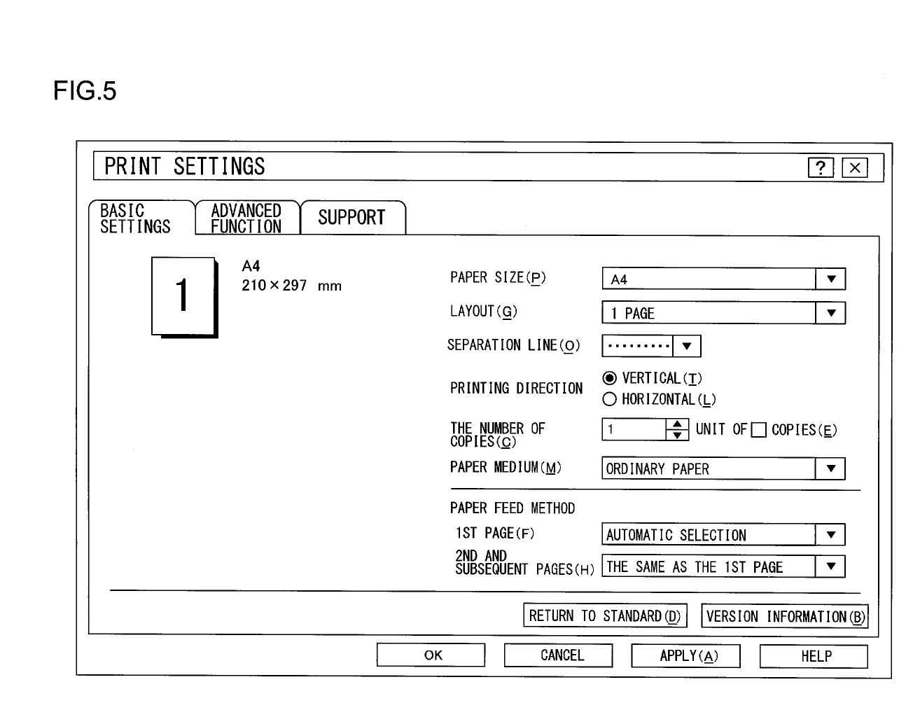

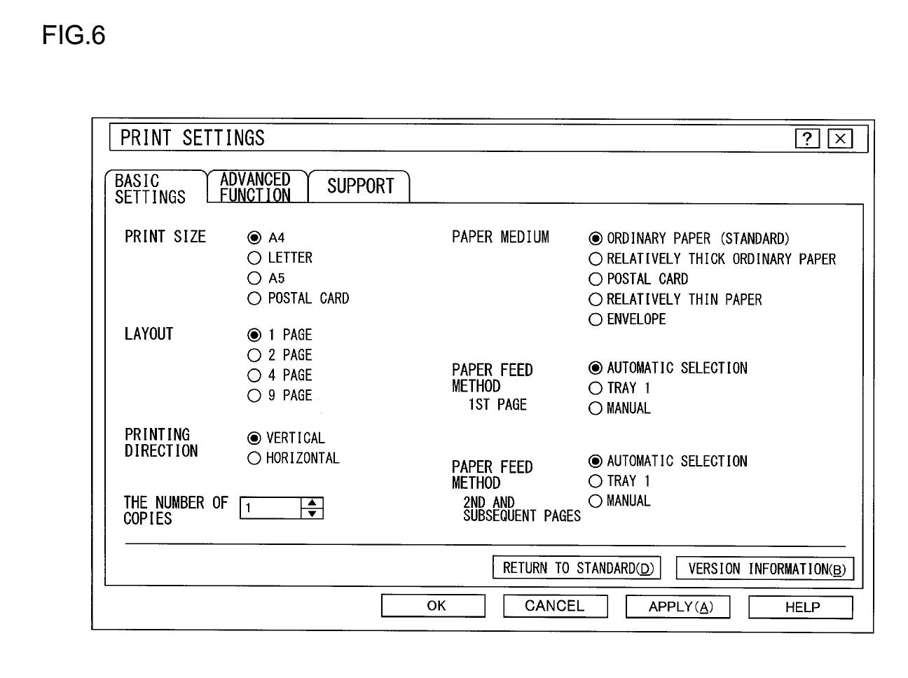

(6) In the above aspects, the installation of the printer driver is performed during the process of the setup work. In this case, a configuration is possible in which a second printer driver for displaying the dialog boxes of the second display aspect is installed, for example, on the condition that the voice reading software has been installed or activated, and a first printer driver for displaying the dialog boxes of the first display aspect is installed under the other conditions. FIGS. 5 and 6 show a dialog box screen displayed when print settings are made in the respective printer drivers. As shown in FIG. 5, in the first printer driver (an example of a “first program”), the pull-down display of options of each print setting item is shown in that configuration. In comparison, in the second printer driver (an example of a “second program”), all the options of each print setting item are shown, so that the options of each print setting item can be read by the voice reading software in this configuration shown in FIG. 6. In other words, a configuration is also possible in which, when a certain program is installed, the program for the first display aspect or the program for the second display aspect is selectively installed depending on whether the voice reading software has been installed or activated. In this case, the CPU 15 executes an “installation selection process”.

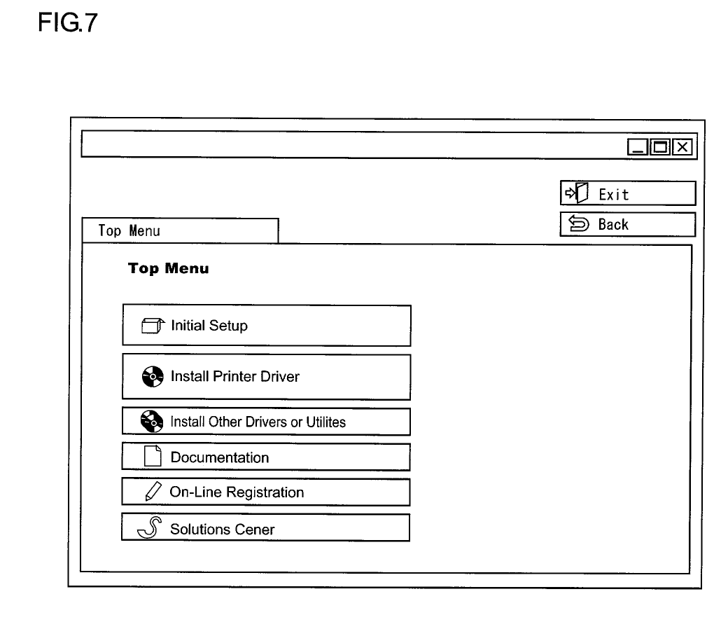

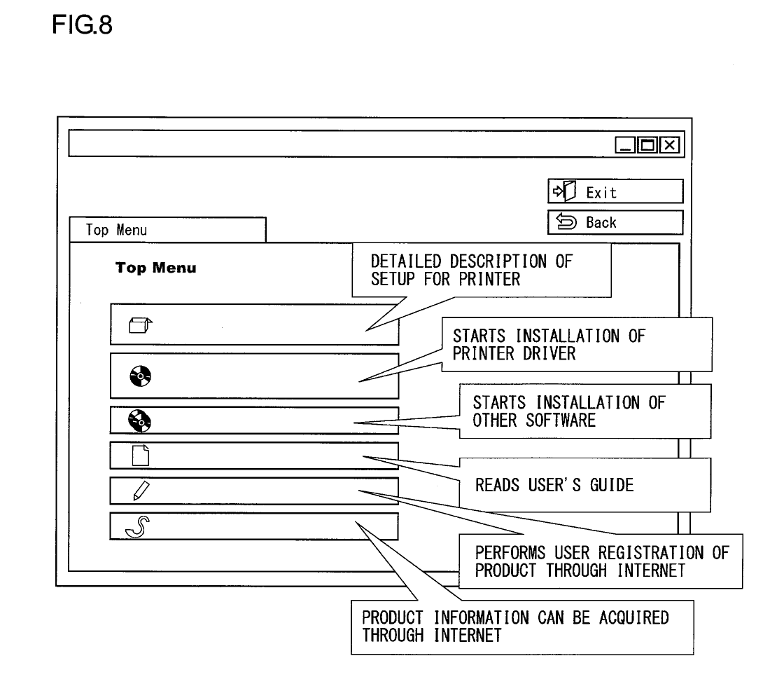

(7) A configuration is also possible in which only the name of each option is displayed in the first display aspect of the dialog box as shown in FIG. 7, and the details of each option are displayed in the second display aspect as shown in FIG. 8. In such a configuration, detailed description of each option can be communicated to a user by voice, by displaying the dialog box of the second display aspect.

What is claimed is:

1. A computer program product including a display control program embodied on a computer-readable medium, the display control program causing a computer capable of accessing a display device to execute:
an installation determination process for determining if voice reading software for making pronunciation based on a character string displayed on the display device has been installed; and
switching process for displaying a dialog box on the display device in a first display aspect when it is determined by the installation determination process that the voice reading software has not been installed, and displaying a dialog box on the display device in a second display aspect when it is determined by the installation determination process that the voice reading software has been installed, wherein the second display aspect is more adaptable to the voice reading software than the first display aspect.

2. The computer program product according to claim 1, wherein
the display control program causes the computer to execute activation determination process for determining whether the voice reading software has been activated or not; and
in the switching process, the dialog box is displayed in the second display aspect when the voice reading software has been installed and activated.

3. The computer program product according to claim 1, wherein
the display control program causes the computer to execute a user's selection process for allowing a user to select whether or not to adopt the display aspect determined by the switching process; and
in the switching process, the dialog box is displayed in the display aspect determined by the switching process only when the user selects the display aspect determined by the switching process, in the user's selection process.

4. The computer program product according to claim 1, wherein a character string related to installation work for a predetermined program is displayed in the dialog box.

5. The computer program product according to claim 1, wherein the display control program causes the computer to execute installation selection process for selectively installing a first program enabling the first display aspect or a second program enabling the second display aspect, in accordance with the determination by the switching process.

6. The computer program product according to claim 1, wherein the first display aspect includes a first character string and the second display aspect includes a second character string.

7. The computer program product according to claim 6, wherein the first character string is simpler that the second character string making the first character string more adaptable than the second character string.

8. The computer program product according to claim 6, wherein the second character string is a larger size than the first character string.

9. The computer program product according to claim 1, wherein a character string indicating the more detailed contents of the dialog box is displayed in the second display aspect than in the first display aspect.

10. The computer program product according to claim 1, wherein a larger-size character string is displayed in the second display aspect than in the first display aspect.

11. A display control method for a dialog box to be displayed on a display device, the method comprising the steps of:
determining if voice reading software for making pronunciation based on a character string displayed on the display device is available; and
displaying a dialog box on the display device in a first display aspect when it is determined that the voice reading software is not available, and displaying a dialog box on the display device in a second display aspect when it is determined that the voice reading software is available, wherein the second display aspect is more adaptable to the voice reading software than the first display aspect.
